(19) United States
(12) Patent Application Publication
(10) Pub. No.: US 2011/0022254 A1
(43) Pub. Date: Jan. 27, 2011

(54) METHOD AND SYSTEM FOR LOCATION ASSISTED POWER MANAGEMENT

(76) Inventors: Michael Johas Teener, Santa Cruz, CA (US); Bruce Currivan, Dove Canyon, CA (US); Wael Diab, San Francisco, CA (US); Jeyhan Karaoguz, Irvine, CA (US); Yongbum Kim, San Jose, CA (US); Kenneth Ma, Cupertino, CA (US)

Correspondence Address: MCANDREWS HELD & MALLOY, LTD, 500 WEST MADISON STREET, SUITE 3400, CHICAGO, IL, 60661, US

(21) Appl. No.: 12/690,250

(22) Filed: Jan. 20, 2010

Related U.S. Application Data
(60) Provisional application No. 61/228,372, filed on Jul. 24, 2009.

(51) Int. Cl. G06F 1/26; G06F 19/00

(52) U.S. Cl. 701/22; 700/295; 700/291; 180/65.265

(57) ABSTRACT

A communication device may be operable to configure a power management profile for the communication device and/or for one or more devices communicatively coupled to the communication device based on determined location corresponding to the communication device. The power management profile may comprise one or more operational parameters for a plurality of power sources, and may be utilized to control power usage in the communication device and/or the one or more devices. The communication device may be integrated into or be coupled with a hybrid vehicle. The location determination may be performed based on GNSS functions. The power management profile may enable creating and/or modifying operation control data for chargeable power storage devices based on location related data. The operation control data for the chargeable power storage devices may pertain to consumption of power from and/or recharging of the chargeable power storage devices.

### CROSS-REFERENCE TO RELATED APPLICATIONS/INCORPORATION BY REFERENCE

This patent application makes reference to, claims priority to and claims benefit from U.S. Provisional Application Ser. No. 61/228,372 filed on Jul. 24, 2009.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to power management. More specifically, certain embodiments of the invention relate to a method and system for Location assisted power management.

### BACKGROUND OF THE INVENTION

The growth of mobility and system connectivity has been one of the major developments in recent years. As to mobility, the automobile has become an indispensible component of life in most societies. For long time, cars relied solely on fossil fuels. However, more recently, alterative power sources have been sought, both for environmental reasons and because of the nonrenewable nature of fossil fuel. For example, early on development focused on pure electric vehicles, which used electric motors rather than internal combustion engines. Such electric vehicles typically used rechargeable battery systems to store chemical energy that may then be converted into mechanical driving power. The development of electric vehicles, however, has been hampered by various factors, most notably, costs and logistics, the latter of which addressed the need to develop adequate infrastructure to ensure availability of recharging facilities. Consequently, more recently the general trend has been the push for the development of hybrid vehicles. Hybrid vehicles combine the conventional internal combustion propulsion systems electric powertrain that uses rechargeable storage systems. Hybrid technology allows continued use of existing infrastructure but with significantly improved fuel economy, and reducing pollution, because the electric powertrain is used in lieu of the internal combustion propulsion system under certain conditions, for example during acceleration. An added benefit is that the hybrid system may be used to recapture power that would otherwise go unused or is unharnessed. The rechargeable storage systems may be recharged during operation of the vehicle, during braking for example, thus alleviating the need, in whole or part, for use of recharging infrastructure.

The increased mobility of society has also had ancillary effect on communication technologies. This increased mobility has, at least in party, spurred a growth in the need for, and development of mobile communication devices and/or applications. Such mobile communication devices and technologies may enable use of a plurality of wired and/or wireless interfaces to provided data and/or traditional voice based connectivity, even on the move. For example, mobile devices, which enable cellular connectivity, have become a near absolute necessity in today's world. While mobile technology originally evolved from traditional land-based communication technologies, and was merely intended to add an element of mobility to the traditional telephony service, this technology has grown beyond that initial purpose. Many modern mobile technologies, including such technologies as GSM/GPRS/EDGE, UMTS, CDMA2000, and LIE, incorporate substantial data capabilities. Most of today's mobile services comprise such features as text messaging, audio/video streaming, and web browsing. Modern communication devices may also be operable to utilize other wireless interfaces to communicate via, for example, wireless personal area networks (WPAN), wireless local area network (WLAN) interfaces, and/or use of Global Positioning Satellite System (GNSS) interfaces.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for Location assisted power management, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram that illustrates an exemplary automobile that is operable to utilize power management based on locational information, in accordance with an embodiment of the invention.

FIG. 2A is a block diagram that illustrates an exemplary power management system that enables managing power usage based on location information, in accordance with an embodiment of the invention.

FIG. 2B is a block diagram that illustrates an exemplary processing subsystem in a power management system that enables management of power usage based on location information, in accordance with an embodiment of the invention.

FIG. 2C is a block diagram that illustrates an exemplary RF front-end subsystem in a power management system that enables management of power usage based on location information, in accordance with an embodiment of the invention.

FIG. 3 is a flow chart that illustrates use of locational information for power management, in accordance with an embodiment of the invention.

### DETAILED DESCRIPTION OF THE INVENTION

Certain embodiments of the invention may be found in a method and system for Location assisted power management. In various embodiments of the invention, a communication device may be operable to configure a power management profile for the communication device and/or for one or more devices communicatively coupled to the communication device based on determined location corresponding to the communication device. The power management profile may comprise operational parameters for a plurality of power sources, and may be utilized to control power usage in the communication device and/or the one or more devices. The communication device may be integrated into or be coupled with a hybrid vehicle. The location determination may be performed based on GNSS functions. Exemplary GNSS functions may comprise Global Positioning System (GPS) based functions, GLONASS based functions, and/or Galileo based functions.

The power management profile may enable creating and/or modifying operation control data for batteries and/or chargeable power storage devices, which may be managed via the communication device, based on location data. Such location related data may comprise, in addition to location data, topological information for current and/or future locations. The operation control data for the chargeable power storage devices may pertain to consumption of power from and/or recharging of the chargeable power storage devices. The configuration and/or management of consumption and/or recharge of the batteries and/or the chargeable power storage devices may be based on the determined location of the communication device. Location data used in the configuration and/or management of batteries and/or the chargeable power storage devices may comprise additional, location related information, including, for example, topological information for current and/or future locations. Furthermore, anticipated future recharge potential for the batteries and/or chargeable power storage devices may be determined based on determined location and/or location related data. In addition, current power consumption from the batteries and/or chargeable power storage devices may be scheduled based on determined anticipated future recharge potential.

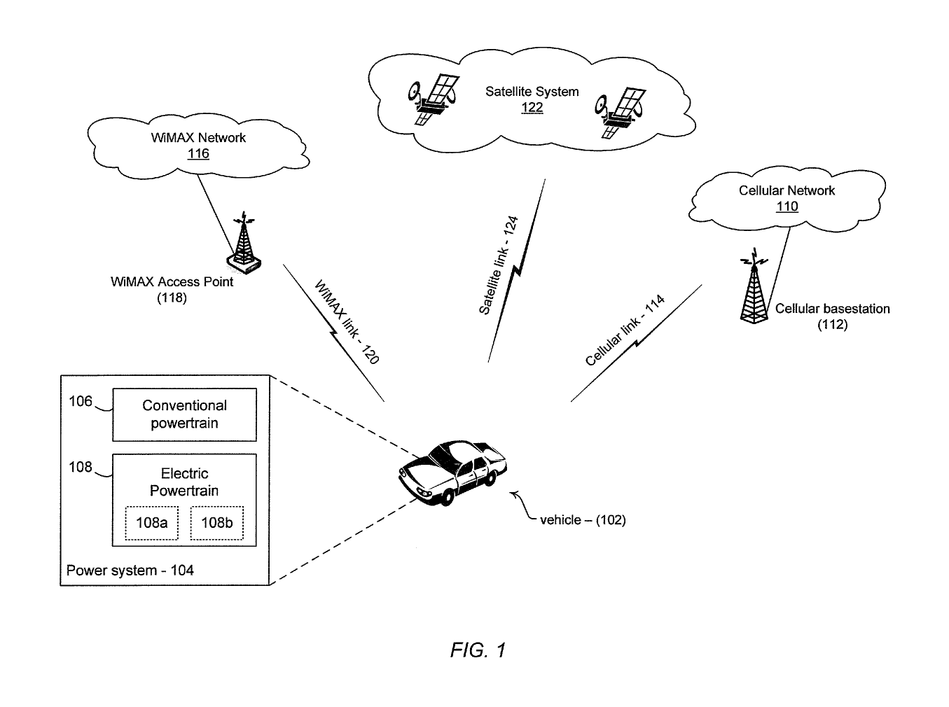

FIG. 1 is a block diagram that illustrates an exemplary automobile that is operable to utilize power management based on locational information, in accordance with an embodiment of the invention. Referring to FIG. 1, there is shown a vehicle 102, a cellular network 110, a cellular base station 112, a cellular link 114, a Worldwide Interoperability for Microwave Access (WiMAX) network 116, a WiMAX access point 118, a WiMAX link 120, a satellite system 122, and a satellite link 124.

The vehicle 120 may comprise a power system 104, which may generate and/or provide power that may be utilized to drive the vehicle 102. The power system 104 may comprise a conventional powertrain 106, which may comprise an internal combustion propulsion system that may utilize conventional fossil fuel and/or bio fuel. In an exemplary aspect of the invention, the power system 104 may incorporate hybrid technology by combining the conventional powertrain 106 with an electric powertrain 106. The electric powertrain 106 may comprise, for example, rechargeable storage subsystem 108a and one or more electric motors (not shown), which may be utilized to drive the vehicle 102 in conjunction with, and/or in lieu of the conventional powertrain 104. The electric powertrain 106 may also comprise a regeneration subsystem 108b, which may be utilized to recharge the rechargeable storage subsystem 108a, from appropriate outlets and/or, for example, under certain conditions during operations of the vehicle 102. For example, the regeneration subsystem 108b may be utilized to recharge the rechargeable storage subsystem 108a by regenerative braking, by capturing deceleration kinetic energy during braking and converting it, via dedicated electric generators and/or using the drive electric motors as electric generator, into chemical energy stored in the rechargeable storage subsystem 108a. The regeneration subsystem 108b may also enable recharging the rechargeable storage subsystem 108a from the conventional powertrain 106, when the rechargeable storage subsystem 108a is depleted beyond a certain threshold for example.

In addition to provide standard vehicular driving operations, the vehicle 102 may comprise one or more devices and/or subsystems that may enable supporting a plurality of wireless interfaces, to facilitate communication with external communication devices and/or networks. The vehicle 102 may be operable, for example, to support and/or utilize the cellular link 114, the WiMAX link 120, and/or the satellite link 124.

The cellular network 110 may comprise one or more cellular base stations 112, and suitable logic, circuitry, interfaces, and/or code that may enable communication via one or more cellular technologies. Exemplary cellular technologies may comprise CDMA, WCDMA, CDMA1000, HSDPA, GSM, GPRS, EDGE, and UMTS. The cellular base station 112 may comprise suitable hardware, logic, circuitry, and/or code that may enable transmission and/or reception of cellular based communications between the cellular network 110 and cellular capable devices, via the cellular link 114. The cellular base station 112 may correspond, for example, to base stations and/or cellular towers and/or within a cellular communication system.

The WiMAX network 116 may comprise a plurality of the WiMAX access points 126, and may comprise suitable logic, circuitry, interfaces, and/or code that may enable Worldwide Interoperability for Microwave Access (WiMAX) compliant communication. The WiMAX access point 118 may comprise suitable hardware, logic, circuitry, and/or code that may enable transmission and/or reception of WiMAX based communications between the WiMAX network 116 and WiMAX capable devices, via the WiMAX link 120.

The satellite system 122 may comprise suitable logic, circuitry, interfaces, and/or code that may enable communication with land-based devices via satellite links, such as, for example, the satellite link 124. The satellite system 122 may be operable to provide positioning information, via satellite links 124 for example, to enable land-based devices to determine their locations. In this regard, the satellite system 122 may comprise, for example, a plurality of orbiting satellite nodes of a global navigation satellite system (GNSS), which may comprise, for example, the Global Positioning System (GPS), GLONASS and/or Galileo based satellite system. The satellite link 124 may enable unidirectional and/or bidirectional communication between the orbiting satellite nodes in the satellite system 122 and land-based devices, for example the vehicle 102. In this regard, the satellite link 124 may be provide positioning information and/or land-based devices may utilize a plurality of the satellite link 124 to determine location using, for example, triangulation based techniques.

In operation, the vehicle 102 may be utilized to provide transportation, enabling the transport of passengers and/or freight for example. During operations of the vehicle 102, the vehicle 102, and/or devices located within vehicle 102, may also be operable to communicate with one or more external devices and/or networks. The vehicle 102, and/or communication devices therein, may enable, for example, connectivity to and/or via a plurality of available networks and/or wireless interfaces. For example, internally integrated systems in vehicle 102 and/or devices communicatively coupled into the vehicle 102 may utilize the cellular link 114 to access the cellular network 110 via the cellular base station 112, and/or may utilize the WiMAX link 120 to access the WiMAX network 116 via the WiMAX access point 118. The vehicle 102 may also be operable to perform satellite based location determination operations. For example, the vehicle 102 may be operable to utilize the satellite link 124 to perform GNSS operations utilizing devices and/or systems directly integrated within the vehicle 102, or utilizing external, dedicated GNSS capable devices communicatively coupled to the vehicle 102.

In an exemplary aspect of the invention, electric and/or hybrid technology may be incorporated into the vehicle 102. For example, the conventional powertrain 106 may be combined with the electric powertrain 108 to enable hybrid based operations of the vehicle 102. During such operations, the electric powertrain 108 may be utilized, under certain conditions, to drive the vehicle 102 in conjunction with, and/or in lieu of the conventional powertrain. The electric powertrain 108 may be utilized primarily, for example, during acceleration phases while the conventional powertrain 106 may be utilized primarily during cruise phases. To further improve operations of the hybrid system, the electric powertrain 108 may also be utilized to recapture and/or regenerate electric power that may subsequently utilized to drive the vehicle 102. For example, the regeneration subsystem 108b may be utilized to recharge the rechargeable storage subsystem 108a during regenerative braking.

In various embodiments of the invention, location based information may be utilized to control and/or manage operations of the power sources utilized in the vehicle 102. Due to its mobility, the location of the vehicle 102 may change, for example, when it travels. Various methods may be utilized to determine the location of the vehicle 102. For example, using the satellite link 124, the vehicle 102 may be operable to determine its location utilizing one or more GNSS functions and/or subsystem. Alternatively, the vehicle 102 may also be operable to determine its location based on other wireless interfaces. The cellular link 114 and/or the WiMAX link 120 may be utilized, for example, to determine location of the vehicle 102, based on location related information included in messaging received via the vehicle 102, for example, and/or using some locational method and/or technical using signals received in the vehicle 102 over these links. Also, once the location of the vehicle 102 is determined, additional, location related information may also be determined based on the location. For example, once the location of the vehicle 102 is determined, topological data or information corresponding to the current location, and/or corresponding to anticipated locations in a predicted route of the vehicle 102 may be determined. Prediction of routes may be based on observation of the direction and speed of the vehicle 102, for example. Consequently, location related information may be utilized to determine, for example, operation profiles for both the conventional powertrain 106 and the electric powertrain 108 in the vehicle 102. For example, the vehicle 102 may take advantage of the anticipated location data to create and/or modify a power management profile may be utilized to manage operations and/or use of the various power sources available in the vehicle 102, via the power system 104 for example. Use, charge, and/or discharge control data, for example, which may be utilized to manage and/or control operations and/or use of the electric powertrain 108 in general, and/or the rechargeable storage subsystem 108a and/or regeneration subsystem 108b thereof in particular, may be generated and/or modified. For example, knowing that an extended downhill lies ahead, the electric powertrain may be used above normal level, or the conventional system may be completely shut off, thus draining rechargeable storage subsystem 108a while lowering use of fuel in anticipation of regenerative braking during the downhill run. The location data may also be utilized, for example, to monitor availability of refueling facilities along the anticipated route of vehicle 102, and accordingly the power management profile may be adjusted to increase use of the electric powertrain to preserve fuel, to ensure, for example, that sufficient fuel remains until reaching the next available refueling facility.

While the invention has been described with regard to hybrid and/or electric vehicles, the invention need not be so confined. Rather, the invention may also be utilized for any system where recharge and/or use control data for rechargeable storage devices are controlled and/or managed based on location data. For example and without limitation, cellular and/or WiMAX communications in a mobile communication device may be held off where location data corresponding to the mobile communication device, which may be ascertained via GNSS functionality, indicates that the mobile communication device may not be sufficiently close to the cellular base station 112 and/or the WiMAX access point 118 without draining battery in the mobile communication device in attempting to conduct such communication.

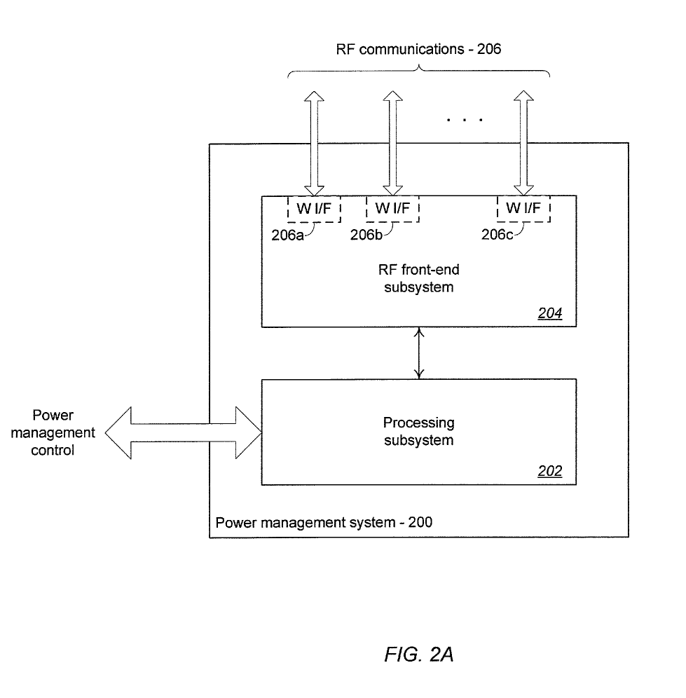

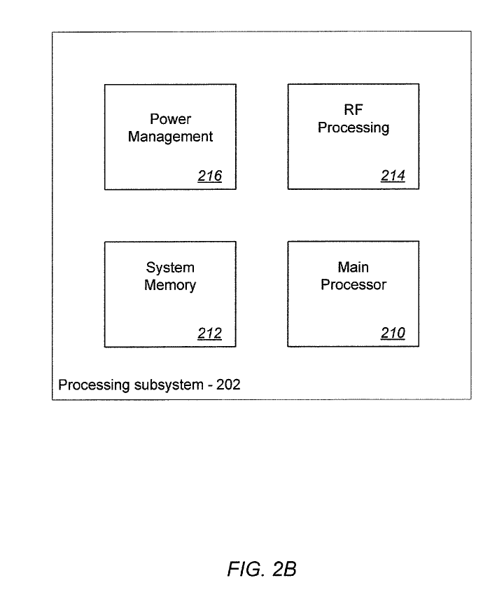

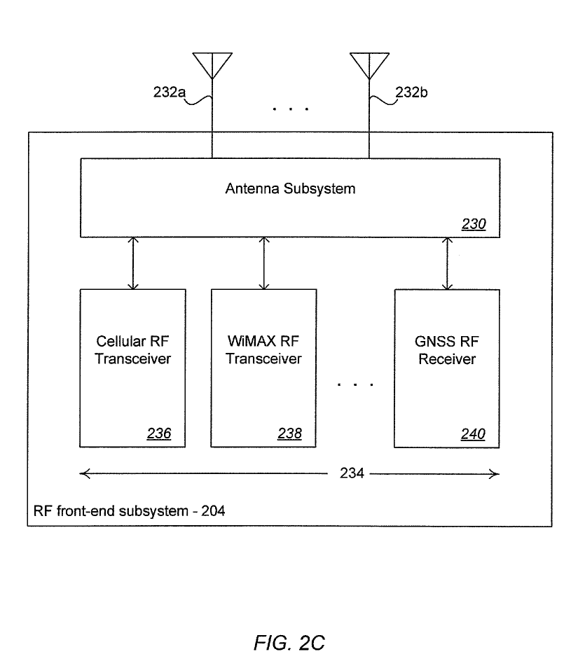

FIG. 2A is a block diagram that illustrates an exemplary power management system that enables managing power usage based on location information, in accordance with an embodiment of the invention. Referring to FIG. 2A, there is shown a power management system 200 comprising a processing subsystem 202 and an RF front-end subsystem 204.

The power management system 200 may comprise the processing subsystem 202, the RF front-end subsystem 204, and suitable logic, circuitry, interfaces, and/or code that may enable performing power management operations using location data, which may be determined based on RF signals received via a plurality of wireless interfaces 206a, . . . , 206c. The wireless interfaces 206a, . . . , 206c may comprise, for example, a WiMAX interface, a cellular interface, and/or satellite (GNSS) interface.

The processing subsystem 202 may comprise suitable logic, circuitry, interfaces, and/or code that may be operable to provide processing and/or control operations in the power management system 200. For example, the processing subsystem 202 may be utilized to generate and/or maintain a power management profile that may be utilized to control operations and/or use of power sources based on, for example, location data determined based on information derived from the RF front-end subsystem 204. The RF front-end subsystem 204 may comprise suitable logic, circuitry, interfaces and/or code that may be operable to perform RF transmission and/or reception, utilizing a plurality of antennas and/or frequency bands, during communications via the plurality of wireless interfaces 206a, . . . , 206c. While the power management system 200 is shown to comprise both processing subsystem 202, the RF front-end subsystem 204, the invention need not be so limited. In some embodiments of the invention, at least some of the components and/or functions described herein may be correspond to external devices and/or systems. For example, dedicated communication systems may be utilized to perform the RF communication operations of the RF front-end subsystem 204.

In operation, the power management system 200 may be integrated in a device, for example the vehicle 102, to provide power management operations based on location data. The power management system 200 may be operable, for example, to generate and/or maintain a power management profile, which may be utilized to manage and/or control operations and/or use of a plurality of power sources where such operations and/or use may be affected by location data. For example, in instances where the power management system 200 is integrated within the vehicle 102, which may comprise the conventional powertrain 106 and the electric powertrain 108 to facilitate hybrid operations, the power management system 200 may be used to generate and/or maintain power management profile that may enable controlling and/or managing control operations and/or use of the conventional powertrain 106 and the electric powertrain 108, substantially as described, for example, with regard to FIG. 1. The location data may be determined via the processing subsystem 202, for example, based on RF signals received via the RF front-end subsystem 204. The RF front-end subsystem 204 may be operable to perform RF signals reception processing corresponding to supported wireless interfaces 206a, . . . , 206c. For example, the RF front-end subsystem 204 may be operable to receive RF signals, which may be operable to determine location corresponding to the power management system 200, via WiMAX, cellular, and/or satellite interfaces.

The processing subsystem 202 may be operable to control and/or manage the operations of the RF front-end subsystem 204, based on, for example, feedback provided via the RF front-end subsystem 204, predefined and/or dynamically determined information, and/or based on input provided to the power management system 200, by the vehicle 102 and/or its user. The processing subsystem 202 may then be operable to process information received via the RF front-end subsystem 204 to determine location corresponding to the power management system 200, and/or corresponding to any device that the power management system 200 may be integrated within and/or may be communicatively coupled with, including, for example, the vehicle 102. For example, the processing subsystem 202 may utilize GNSS based function to determine the location data corresponding to the power management system 200 based on satellite signals received via the RF front-end subsystem 204.

Once the location data is determined, additional, location related information may also be determined based on the location. For example, the processing subsystem 202 may determine, based on location data, topological data or information corresponding to the current location, and/or corresponding to anticipated future locations based on, for example, predicted travel route for the vehicle 102. The processing subsystem 202 may then modify, based on the location data, the power management profile. For example, the processing subsystem 202 may be operable to modify use and/or recharge data for the electric powertrain 108 by generating and/or modifying control data corresponding to the rechargeable storage subsystem 108a and/or regeneration subsystem 108b in the electric powertrain 108, substantially as described with regard to, for example, FIG. 1.

FIG. 2B is a block diagram that illustrates an exemplary processing subsystem in a power management system that enables management of power usage based on location information, in accordance with an embodiment of the invention. Referring to FIG. 2B, there is shown the processing subsystem 202 comprising a main processor 210, a system memory 212, a RF processing module 214, and a power management module 216.

The processing subsystem 202 may comprise the main processor 210, the system memory 212, the RF processing module 214, the power management module 216, and/or suitable logic, circuitry, interfaces, and/or code that may enable performing location based power management operations, substantially as described with regards to FIG. 2A. The processing subsystem 202 may be operable to generate and/or maintain a power management profile that may be utilized to manage and/or control a plurality of power sources in a device based on, inter alia, location data.

The main processor 210 may comprise suitable logic, circuitry, interfaces, and/or code that may enable controlling, managing and/or supporting processing operations in the processing subsystem 202 and/or the power management system 200. The main processor 210 may be utilized to control at least a portion of the system memory 212, the RF processing module 214, the power management module 216, and/or the RF front-end subsystem 204. In this regard, the main processor 210 may generate, for example, signals for controlling operations within the processing subsystem 202 and/or the RF front-end subsystem 204. The main processor 210 may also enable execution of applications that may be utilized by the processing subsystem 202. The invention need not be limited to a specific processor, and the main processor 210 may comprise for example, a general purpose processor, a specialized processor or any combination of suitable hardware, firmware, software and/or code, which may be enabled to support and/or control operations of the power management system 202.

The system memory 212 may comprise suitable logic, circuitry, interfaces, and/or code that may enable permanent and/or non-permanent storage and/or fetch of data, code and/or other information used in the processing subsystem 202 and/or the RF front-end subsystem 204. In this regard, the system memory 212 may comprise different memory technologies, including, for example, read-only memory (ROM), random access memory (RAM), and/or Flash memory. The system memory 212 may be utilized, for example, for storage of configuration data and/or execution code that is utilized by the main processor 210. The system memory 212 may also be utilized to store configuration and/or management information which may be utilized to control the operations of at least a portion of the RF front-end subsystem 204.

The RF processing module 214 may comprise suitable logic, circuitry, interfaces, and/or code that may provide dedicated processing operations during RF reception operations in the power management system 200. The RF processing module 214 may enable, for example, processing of baseband signals during reception of RF signals via the RF front-end subsystem 204. The RF processing module 214 may also be operable to generate control and/or processing signals, such as local oscillator signals, to facilitate performing conversion and/or modulation operations during reception of RF signals. Although the RF processing module 214 may be depicted as a single block, the invention need not be so limited. Accordingly, other embodiments of the invention may comprise a plurality of baseband processors for processing signals for one or more available RF transceivers.

The power management module 216 may comprise suitable logic, circuitry, interfaces, and/or code that may provide dedicated power management processing operations in the power management system 200. The power management module 216 may be operable, for example, to generate and/or maintain a power management profile that enables controlling and/or managing operations and/or use of a plurality of power sources. In an exemplary aspect of the invention, the power management module 216 may configure the power management profile based on, in part or in whole, location data. Accordingly, the power management module 216 may be operable to process location data which may be determined, for example, based on RF signals received via the RF front-end subsystem 204.

In operation, the processing subsystem 202 may be operable to control and/or manage the operations of the RF front-end subsystem 204. The main processor 210 and/or the RF processing module 214 may enable configuring of the RF front-end subsystem 204, based on configuration information stored via the system memory 212 for example, to facilitate reception of RF signals via wireless interfaces supported via the RF front-end subsystem 204. The main processor 210 may also enable processing feedback provided via the RF front-end subsystem 204, utilizing, for example, predefined parameters stored via the system memory 212, dynamically determined information during processing operations, and/or input provided into the power management system 200. For example, the main processor 210 may configure the RF front-end subsystem 204 to facilitate reception of satellite signals that may be utilized in location determination using GNSS based functionality.

In an embodiment of the invention, the processing subsystem 202 may be utilized to generate and/or maintain power management profile, which may be utilized to manage and/or control operations and/or use of a plurality of power sources in a device, for example the vehicle 102, based on location data. For example, the power management module 216 may generate and/or maintain one or more power management profiles that may enable controlling and/or managing control operations and/or use of the conventional powertrain 106 and the electric powertrain 108 in the vehicle 102. The power management profile may be maintained directly within the power management module 216, and/or may be stored in the system memory 212. To facilitate location based power management operations, the main processer 210 and/or the RF processing module 214 may be utilized to configure the RF front-end subsystem 204 to receive RF signals that may enable determining location data, using, for example, satellite signals and GNSS based function.

The power management module 216 may also be operable to extract additional information based on location data, including, for example, topological data or information corresponding to the current location and/or anticipated future location in a predicted route of the vehicle 102. The power management module 216 may also be operable to continually communicate with power sources in the vehicle 102, to determine availability of power from each source. The power management module 216 may then anticipated recharge and/or use data based on the determined location data and/or input from the power sources. The power management module 216 may modify the power management profile based on this input, and/or any configuration data that may be retrieved from, for example, the system memory 212. The modified power management configuration profile may be used to change, for example, use and/or recharge control data which may be utilized to control operations of the rechargeable storage subsystem 108a and/or regeneration subsystem 108b in the electric powertrain 108.

FIG. 2C is a block diagram that illustrates an exemplary RF front-end subsystem in a power management system that enables management of power usage based on location information, in accordance with an embodiment of the invention. Referring to FIG. 2C, there is shown the RF front-end subsystem 204 comprising an antenna subsystem 230, and a plurality of antennas 232a, . . . , 232b, and a plurality of RF transceivers 234, which may comprise a cellular RF transceiver 236, a WiMAX RF transceiver 238, and a GNSS RF receiver 240.

The RF front-end subsystem 204 may comprise, for example, the antenna subsystem 230, and a plurality of antennas 232a, . . . , 232b, and a plurality of RF transceivers 234, and/or suitable logic, circuitry, interfaces and/or code that may enable performing RF communications via one or more wireless interfaces. The cellular RF transceiver 236 may comprise suitable logic, circuitry, interfaces, and/or code that may enable performing cellular communications. Exemplary cellular interfaces comprise GSM, UMTS, CDMA2000 and/or WCDMA. The cellular RF transceiver 236 may be operable, for example, to enable processing of transmitted and/or received cellular based RF signals via the antenna subsystem 230 and one or more of the plurality of antennas 232a, . . . , 232b. The cellular RF transceiver 236 may be operable, for example, to perform amplification, filtering modulation and/or conversion processing operations to facilitate transmission and/or reception of RF signals at appropriate and/or configured frequencies.

The WiMAX RF transceiver 238 may comprise suitable logic, circuitry, interfaces, and/or code that may enable performing WiMAX communications. The WiMAX RF transceiver 238 may be operable, for example, to enable processing of transmitted and/or received WiMAX based RF signals via the antenna subsystem 230 and one or more of the plurality of antennas 232a, . . . , 232b. The WiMAX RF transceiver 238 may be operable, for example, to perform amplification, filtering modulation and/or conversion processing operations to facilitate transmitting and/or receiving of RF signals at appropriate and/or configured frequencies.

The GNSS RF receiver 240 may comprise suitable logic, circuitry, interfaces, and/or code that may enable performing GNSS communications. Exemplary GNSS interfaces may comprise, for example, GPS, GLONASS and/or Galileo satellite systems based interfaces. The GNSS RF receiver 240 may be operable, for example, to enable processing of received GNSS signals via the antenna subsystem 230 and one or more of the plurality of antennas 232a, . . . , 232b. The GNSS RF receiver 240 may be operable, for example, to perform amplification, filtering modulation and/or conversion processing operations to facilitate reception of RF signals at appropriate and/or configured frequencies.

The antenna subsystem 230 may comprise suitable logic, circuitry, interfaces, and/or code that may enable switching and/or routing of RF signals processed via the cellular RF transceiver 236, the WiMAX RF transceiver 238, and/or the GNSS RF receiver 240, which may be communicated via one or more of the plurality of antennas 232a, . . . , 232b. Each of the plurality of antennas 232a, . . . , 232b may comprise suitable logic, circuitry, interfaces, and/or code that enable transmission and/or reception of RF signals within certain bandwidths corresponding to one or more supported wireless protocols. For example, one or more of the plurality of antennas 232a, . . . , 232b may enable RF transmission and/or reception via the 2.4 GHz, which is suitable for WiMAX communication while other antennas may be configured for reception of GNSS signals. The plurality of antennas 232a, . . . , 232b may be communicatively coupled to the antenna subsystem 230.

In operation, the RF front-end subsystem 204 may be operable to perform, via the plurality of RF transceivers 234, the antenna subsystem 230, and/or the plurality of antennas 232a, . . . , 232b RF transmission and/or reception that is necessary facilitate communications pertaining to supported wireless interfaces. For example, during cellular communication, the cellular RF transceiver 236 may be operable to communication cellular specific RF signals that are utilized to communicate cellular based data. RF signaling may be routed via the antenna subsystem 230 to facilitate over-the-air transmission and/or reception of the RF signals via one or more of the plurality of antennas 232a, . . . , 232b. In an exemplary aspect of the invention, at least some of the plurality of antennas 232a, . . . , 232b, and/or one or more of the RF transceivers 234 may be utilized to receive RF signal that may be utilized to generate location related data in the power management system 200. For example, the antenna 232a may be configured to enable reception RF bandwidths corresponding to satellite signals of one or more GNSS standards. The received GNSS satellite signals may then be routed via the satellite subsystem 230 to the GNSS RF receiver 240. The GNSS RF receiver 240 may process the received signals, and data corresponding the GNSS satellite signal, which may be used to determine a location corresponding to power management system 200, may then be communicated to the processing subsystem 202, to facilitate location based power management operations, substantially as described with regard to, for example, FIG. 2B.

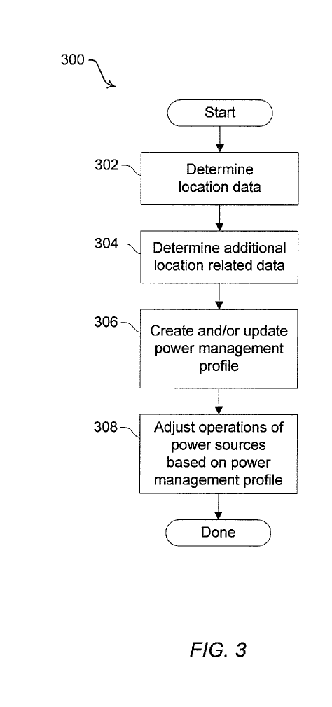

FIG. 3 is a flow chart that illustrates use of locational information for power management, in accordance with an embodiment of the invention. Referring to FIG. 3, there is shown a flow chart 300 comprising a plurality of exemplary steps that may be utilized during Location assisted power management.

In step 302, location data may be determined. For example, the power management system 200 may be operable to determine current location of the vehicle 102 using GNSS function where the RF front-end subsystem 204 may be utilized to receive satellite signals corresponding to one or more GNSS interfaces, and the processing subsystem 202 may be operable to extract location data based on received satellite signals. The processing subsystem 202 may also be operable to determine location data corresponding to anticipated future locations based on predicted travel route for the vehicle 102. In step 304, additional location related data may be determined. For example, the processing subsystem 202 may be operable to, in the power management system 200, determine topological data or information corresponding to current and/or future location data. Such topological information may be relevant for ascertaining, for example, favorable conditions for charging and/or using the electric powertrain 108.

In step 306, power management profile, which may be utilized to manage and/or control a plurality of power sources in a device, may created and/or modified based on determined location data and/or additional, location related information. For example, the power management module 216 in the processing subsystem 202 may be utilized to generate, maintain, and/or modify power management profile corresponding to the conventional powertrain 106 and the electric powertrain 108 in the vehicle 102. Based on determined location data and/or location related information, the power management module 216 may be operable to generate and/or modify the power management profile for the power system 104 in the vehicle 102. The changes may affect, for example, use, charge, and/or recharge control data for the rechargeable storage subsystem 108a and/or the regeneration subsystem 108b. For example, instances where upcoming steep and long downhill is determined, the power management profile may be adjusted, via the power management module 216 to increase use of the electric powertrain 108 since the rechargeable storage subsystem 108a may be recharged efficiently during the downhill run. In step 308, the generated and/or modified power management profile may be utilized to control and/or modify operations of the plurality of power sources in the controlled device. For example, the power management profile generated and/or modified via the power management module 216 may be used to control operations of the conventional powertrain 108 and/or the electric powertrain 108 in the vehicle 102.

Various embodiments of the invention may comprise a method and system for Location assisted power management. The power management system 200 may be operable to generate and/or configure power management profiles, which may comprise operational parameters for, and may be utilized to manage and/or control power usage of a plurality of power sources, based on determined location corresponding to the power management system 200. For example, the power management system 200 may be integrated into, or be coupled with the vehicle 102, and may be utilized to manage and/or control power usage of the power system 104. The power management profile may comprise operational parameters for a plurality of power sources, and may be utilized to control power usage of the conventional subsystem 106 and/or the electric subsystem 108 in the power system 104 in the vehicle 102. The location determination may be performed using GNSS functions, based on satellite signals received via the RF front-end subsystem 204. Exemplary GNSS functions may comprise Global Positioning System (GPS) based functions, GLONASS based functions, and/or Galileo based functions. The power management profile may enable creating and/or modifying operation control data for the rechargeable storage subsystem 108a and/or the regeneration subsystem 108b, which may be managed via the power management system 200, based on location data. Such location related data may comprise, in addition to location data, topological information for current and/or future locations. The operation control data for the chargeable power storage devices may pertain to consumption of power from and/or recharging of the chargeable power storage devices. The configuration and/or management of consumption and/or recharge of the rechargeable storage subsystem 108a, and/or of the regeneration subsystem 108b, may be determined based on the locations corresponding to the vehicle 102. Location data used in the configuration and/or management of the rechargeable storage subsystem 108a and/or the regeneration subsystem 108b may also comprise additional, location related information, including, for example, topological information for current and/or future locations, which may be determined via the processing subsystem 202. Furthermore, anticipated future recharge potential for the rechargeable storage subsystem 108a and/or the regeneration subsystem 108b may be determined, via the power management module 216, based on determined location and/or location related data. In addition, current power consumption from the rechargeable storage subsystem 108a and/or the regeneration subsystem 108b may be scheduled, via the power management module 216, based on determined anticipated future recharge potential.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for Location assisted power management.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for power management, the method comprising:
performing by one or more processors and/or circuits in a communication device:
determining a location of said communication device;
configuring a power management profile for said communication device and/or for one or more other devices that are communicatively coupled to said communication device, based on said determined location of said communication device, wherein said power management profile comprises at least one operational parameter that enables said communication device and/or said one or more other devices to utilize power from a plurality of power sources; and
controlling power usage of said communication device and/or said one or more devices based on said configured power management profile.

2. The method according to claim 1, wherein said communication device is integrated into a hybrid and/or an electric vehicle.

3. The method according to claim 1, comprising determining said location of said communication device using signals received on a global navigational satellite system (GNSS) interface within or communicatively coupled to said communication device.

4. The method according to claim 3, wherein said GNSS interface comprises a Global Positioning System (GPS) interface, a GLONASS interface, and/or a Galileo interface.

5. The method according to claim 1, wherein said configuring of said power management profile comprises creating and/or modifying operation control data for one or more batteries and/or chargeable power storage devices that are managed by said communication device.

6. The method according to claim 5, wherein said operation control data for said one or more batteries and/or chargeable power storage devices comprises control data corresponding to consumption of power from and/or recharging of said one or more batteries and/or chargeable power storage devices.

7. The method according to claim 6, comprising configuring and/or managing said consumption and/or recharge of said batteries and/or chargeable power storage devices based on said determined location of said communication device.

8. The method according to claim 7, comprising performing said configuration and/or management based on topological data corresponding to said determined location.

9. The method according to claim 7, comprising determining anticipated future recharge potential for said batteries and/or chargeable power storage devices based on said determined location.

10. The method according to claim 9, comprising scheduling current power consumption from said batteries and/or chargeable power storage devices based on said determined anticipated future recharge potential.

11. A system for power management, the system comprising:
one or more circuits in a device that are operable to determine a location of said communication device; and
said one or more circuits are operable to configure a power management profile for said communication device and/or for one or more other devices that are communicatively coupled to said communication device, based on said determined location of said communication device, wherein said power management profile comprises at least one operational parameter that enables said communication device and/or said one or more other devices to utilize power from a plurality of power sources; and
said one or more circuits are operable to control power usage of said communication device and/or said one or more devices based on said configured power management profile.

12. The system according to claim 11, wherein said communication device is integrated into a hybrid and/or an electric vehicle.

13. The system according to claim 11, wherein said one or more circuits are operable to determine said location of said communication device using signals received on a global navigational satellite system (GNSS) interface within or communicatively coupled to said communication device.

14. The system according to claim 13, wherein said GNSS interface comprises a Global Positioning System (GPS) interface, a GLONASS interface, and/or a Galileo interface.

15. The system according to claim 11, wherein said configuring of said power management profile comprises creating and/or modifying operation control data for one or more batteries and/or chargeable power storage devices that are managed by said communication device.

16. The system according to claim 15, wherein said operation control data for said one or more batteries and/or chargeable power storage devices comprises control data corresponding to consumption of power from and/or recharging of said one or more batteries and/or chargeable power storage devices.

17. The system according to claim 16, wherein said one or more circuits are operable to configure and/or manage said consumption and/or recharge of said batteries and/or chargeable power storage devices based on said determined location of said communication device.

18. The system according to claim 17, wherein said one or more circuits are operable to perform said configuration and/or management based on topological data corresponding to said determined location.

19. The system according to claim 17, wherein said one or more circuits are operable to determine anticipated future recharge potential for said batteries and/or chargeable power storage devices based on said determined location.

20. The system according to claim 19, wherein said one or more circuits are operable to schedule current power consumption from said batteries and/or chargeable power storage devices based on said determined anticipated future recharge potential.
